(19) United States
(12) Patent Application Publication
(10) Pub. No.: US 2007/0120749 A1
(43) Pub. Date: May 31, 2007

(54) Portable electronic device with a slot antenna

(75) Inventors: Tiao-Hsing Tsai, Yungho City (TW); Chao-Chiang Kuo, Chung Li City (TW); Ying-Chih Wang, Kuei Shan Hsiang (TW)

Correspondence Address: LADAS & PARRY, Suite 2100, 5670 Wilshire Boulevard, Los Angeles, CA, 90036-5679, US

(73) Assignee: QUANTA COMPUTER, INC.

(21) Appl. No.: 11/386,013

(22) Filed: Mar. 20, 2006

(30) Foreign Application Priority Data
Nov. 30, 2005 (TW) 094142082

(51) Int. Cl. H01Q 1/24

(52) U.S. Cl. 343/702

(57) ABSTRACT

A portable electronic device includes a metallic casing, a circuit board, a feeding line, and a grounding line. The metallic casing confines an accommodating space, and is formed with a slot that is in spatial communication with the accommodating space and that is defined by a slot-defining wall. The circuit board is disposed in the accommodating space, and is provided with feeding and grounding ports. The feeding line serves to couple electrically the feeding port to the slot-defining wall. The grounding line serves to couple electrically the grounding port to the slot-defining wall.

### CROSS-REFERENCE TO RELATED APPLICATION

This application claims priority of Taiwanese application no. 094142082, filed on Nov. 30, 2005.

### BACKGROUND OF THE INVENTION

1. Field of the Invention

This invention relates to a portable electronic device, more particularly to a portable electronic device that includes a slot antenna.

2. Description of the Related Art

FIG. 1 illustrates a conventional portable electronic device 1 that includes a casing 11, a circuit board 10, and a planar inverted-F antenna (PIFA) 12. The casing 11 is made from metal (or coated with a metal-containing painting), and confines an accommodating space. The circuit board 10 is disposed in the accommodating space. The PIFA 12 is disposed in the accommodating space, is coupled electrically to the circuit board 10, and is operable within the 2.4 GHz to 2.5 GHz Industrial, Scientific, and Medical (ISM) band.

Based from experimental results, the PIFA 12 of the conventional portable electronic device 1 has antenna gains of −1 dBi, −0.7 dBi, and −1.2 dBi when operated at 2.4 GHz, 2.45 GHz, and 2.5 GHz, respectively.

The aforementioned conventional portable electronic device 1 is disadvantageous in that, since the casing 11 is made from metal, which is the current trend in portable electronic devices, the antenna gain of the PIFA 12 is considerably deteriorated.

It has been proposed heretofore to replace a portion 111 of the casing 11, which is proximate to the PIFA 12, with a non-metallic material, such as plastics, to solve the above problem. This, however, results in a complex manufacturing process for the casing 11 and has an adverse effect on the appearance of the casing 11.

### SUMMARY OF THE INVENTION

Therefore, the object of the present invention is to provide a portable electronic device that can overcome the aforesaid drawbacks of the prior art.

According to the present invention, a portable electronic device comprises a metallic casing, a circuit board, a feeding line, and a grounding line. The metallic casing confines an accommodating space, and is formed with a slot that is in spatial communication with the accommodating space and that is defined by a slot-defining wall. The circuit board is disposed in the accommodating space, and is provided with feeding and grounding ports. The feeding line serves to couple electrically the feeding port to the slot-defining wall. The grounding line serves to couple electrically the grounding port to the slot-defining wall.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional portable electronic device with a planar inverted-F antenna;

FIG. 2 is a perspective view of the first preferred embodiment of a portable electronic device with a slot antenna according to the present invention;

FIG. 3 is a schematic partly cutaway view to illustrate the slot antenna of the preferred embodiment;

FIG. 4 is a plot illustrating a voltage standing wave ratio of the slot antenna of the preferred embodiment;

FIG. 5 is a perspective view of the second preferred embodiment of a portable electronic device with a slot antenna according to the present invention; and

FIG. 6 is a perspective view of the third preferred embodiment of a portable electronic device with a slot antenna according to the present invention.

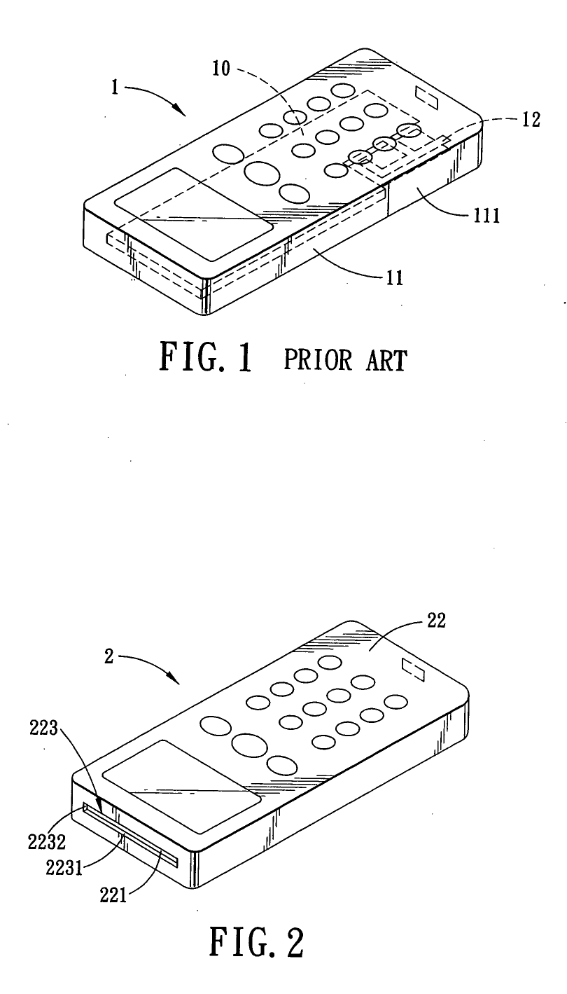

### DETAILED DESCRIPTION OF THE PREFERRED EMBODIMENTS

Before the present invention is described in greater detail, it should be noted that like elements are denoted by the same reference numerals throughout the disclosure.

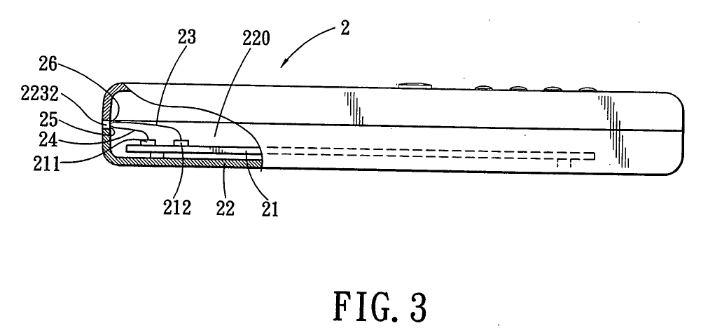

Referring to FIGS. 2 and 3, the first preferred embodiment of a portable electronic device 2 according to this invention is shown to include a metallic casing 22, a circuit board 21, a feeding line 23, and a grounding line 24.

In this embodiment, the portable electronic device 2 is in the form of a mobile phone.

The portable electronic device 2 of this embodiment is capable of connecting with other electronic devices (not shown) through Bluetooth or Wi-Fi technologies, in a manner that will be described hereinafter.

The casing 22 confines an accommodating space 220, and is formed with a slot 221 that is in spatial communication with the accommodating space 220 and that is defined by a slot-defining wall 223. In this embodiment, the slot-defining wall 223 is generally rectangular in shape, and has a longer wall surface 2231, and a shorter wall surface 2232, which has a length shorter than that of the longer wall surface 2231.

The casing 22 and the slot 221 cooperatively constitute a slot antenna for operation within the 2.4 GHz to 2.5 GHz Industrial, Scientific, and Medical (ISM) band.

The circuit board 21 is disposed in the accommodating space 220, and is provided with feeding and grounding ports 211, 212.

The feeding line 24 couples electrically the feeding port 211 to a first connecting point 25 that is provided on the shorter wall surface 2232 of the slot-defining wall 223.

The grounding line 23 couples electrically the grounding port 212 to a second connecting point 26 that is spaced apart from the first connecting point 25 and that is provided on the shorter wall surface 2232 of the slot-defining wall 223.

In this embodiment, each of the feeding and grounding lines 24, 23 is a micro strip line. In an alternative embodiment, each of the feeding and grounding lines 24, 23 is a conductive lead.

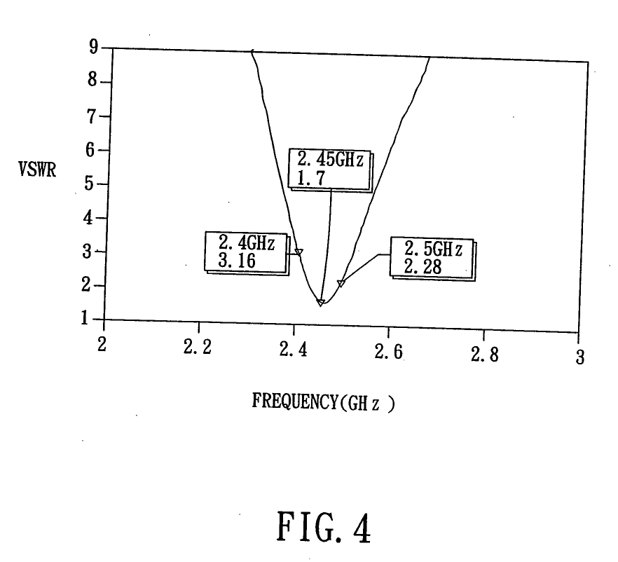

Based from experimental results, as illustrated in FIG. 4, the slot antenna of the portable electronic device 2 of this invention achieves a voltage standing wave ratio (VSWR) of 1.7 when operated at 2.45 GHz. Moreover, the slot antenna of the portable electronic device 2 of this invention has antenna gains of 0.8 dBi, 1.5 dBi, and 0.5 dBi when operated at 2.4 GHz, 2.45 GHz, and 2.5 GHz, respectively.

By forming the casing 22 of the portable electronic device 2 of this invention into a slot antenna, the aforesaid drawbacks associated with the prior art can be eliminated.

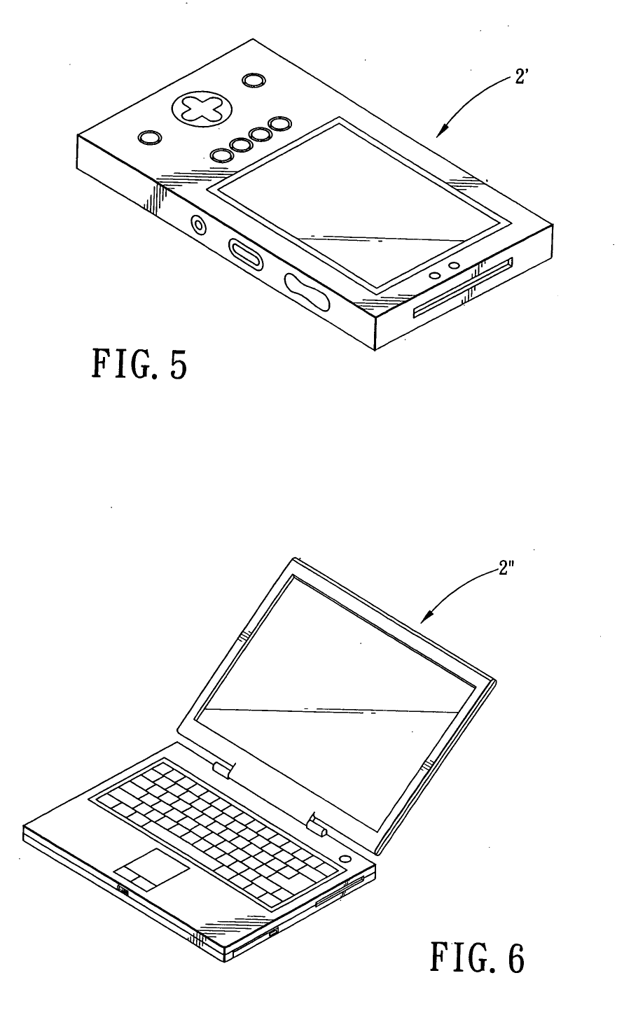

FIG. 5 illustrates the second preferred embodiment of a portable electronic device 2′ according to this invention. In this embodiment, the portable electronic device 2′ is in the form of a personal digital assistant.

FIG. 6 illustrates the third preferred embodiment of a portable electronic device 2″ according to this invention. In this embodiment, the portable electronic device 2″ is in the form of a notebook computer.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A portable electronic device, comprising:
a metallic casing confining an accommodating space, and formed with a slot that is in spatial communication with said accommodating space and that is defined by a slot-defining wall;
a circuit board disposed in said accommodating space, and provided with feeding and grounding ports;
a feeding line for coupling electrically said feeding port to said slot-defining wall; and
a grounding line for coupling electrically said grounding port to said slot-defining wall.

2. The portable electronic device as claimed in claim 1, wherein said slot-defining wall is generally rectangular in shape, and has longer and shorter wall surfaces, said shorter wall surface having a length that is shorter than that of said longer wall surface, said feeding line coupling electrically said feeding port to said shorter wall surface of said slot-defining wall, said grounding line coupling electrically said grounding port to said shorter wall surface of said slot-defining wall.

3. The portable electronic device as claimed in claim 2, further comprising:
a first connecting point provided on said shorter wall surface of said slot-defining wall, said feeding line coupling electrically said feeding port to said first connecting point, and
a second connecting point spaced apart from said first connecting point and provided on said shorter wall surface of said slot-defining wall, said grounding line coupling electrically said grounding port to said second connecting point.

4. The portable electronic device as claimed in claim 1, wherein said casing and said slot cooperatively constitute a slot antenna that is operable within 2.4 GHz to 2.5 GHz band.

5. The portable electronic device as claimed in claim 1, wherein said portable electronic device is in the form of a mobile phone.

6. The portable electronic device as claimed in claim 1, wherein said portable electronic device is in the form of a personal digital assistant.

7. The portable electronic device as claimed in claim 1, wherein said portable electronic device is in the form of a notebook computer.
